(19) United States
(12) Patent Application Publication
(10) Pub. No.: US 2009/0199087 A1
(43) Pub. Date: Aug. 6, 2009

(54) APPLYING RICH VISUAL EFFECTS TO ARBITRARY RUNS OF TEXT

(75) Inventors: Said Saad Abou-Hallawa, Redmond, WA (US); Shailesh Saini, Seattle, WA (US); Stuart Jay Stuple, Redmond, WA (US); Peter R. Amstein, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/025,709

(22) Filed: Feb. 4, 2008

(51) Int. Cl. G06F 17/21

(52) U.S. Cl. 715/243

(57) ABSTRACT

Technologies are described herein for applying rich visual effects to arbitrary runs of text. The dimensions of the run of text following the application of the rich visual effect are determined. Once the dimensions of the run of text following the application of the rich visual effect have been determined, a layout for the run of text is determined utilizing the dimensions of the run of text following the application of the rich visual effect. The run of text is then rendered according to the layout with the rich visual effect applied thereto. Layout functions and typographical functions may be utilized in conjunction with the run of text prior to and following the application of the rich visual effect to the run of text.

### BACKGROUND

Computer programs exist today that provide an extremely rich array of layout and typographical capabilities for composing text. For instance, many word processing application programs provide extensive functionality for laying out and formatting text. These programs, however, do not allow rich visual effects, such as a reflection, glow, and bevel effects, to be applied to arbitrary runs of text.

Some application programs allow rich visual effects to be applied to small runs of text. This functionality, however, is generally only permitted for small runs of text that do not participate fully in the document layout and to which only limited typographical functions can be applied. For instance, in some application programs functionality for spelling or grammar checking, generating a bibliography or table of contents, and other functions cannot be utilized on runs of text to which rich visual effects have been applied.

It is with respect to these considerations and others that the disclosure made herein is presented.

### SUMMARY

Technologies are described herein for applying rich visual effects to arbitrary runs of text. In particular, through the use of the technologies and concepts presented herein, rich visual effects can be applied to any run of text while maintaining the ability of the text to participate fully in document layout and while preserving all typographical capabilities. In this manner, rich visual effects, such as reflection, glow, and bevel effects, can be applied to any text in a document without restricting the layout and typographical functions that may be applied to the effected text.

According to one aspect presented herein, a request is received to apply a rich visual effect to a run of text. For instance, a user may utilize an appropriate user input device to select a run of text and to select a user interface control for applying the rich visual effect to the run of text. In response to such a request, the dimensions of the run of text following the application of the rich visual effect are determined. In one embodiment, the dimensions are determined without rendering the run of text with the rich visual effect applied thereto, such as through the use of a parameter associated with the rich visual effect that indicates how the dimensions of the run of text will be modified following the application of the rich visual effect to the run of text. The parameter may indicate, for instance, that application of a glow effect will cause the height and width of a run of text to increase by a specified percentage. The parameter may be specified in absolute or relative terms.

Once the dimensions of the run of text following the application of the rich visual effect have been determined, a layout for the run of text is generated utilizing the dimensions of the run of text following the application of the rich visual effect. For instance, the dimensions may be utilized to determine a page break for the page containing the run of text. In one implementation, the run of text and the dimensions are provided to a line services component. The line services component determines the layout for the run of text and returns layout data that indicates how the run of the text should be laid out. The layout data returned from the line services component is utilized to determine the layout for the run of text. The run of text is then rendered according to the layout with the rich visual effect applied thereto.

According to aspects, layout functions, typographical functions, and word processing functions, such as those utilized by a word processing application program, may be utilized in conjunction with the run of text prior to the application of the rich visual effect to the run of text. The layout functions, typographical functions, and word processing functions can also be utilized with the run of text following the application of the rich visual effect to the run of text. Word processing functions include functions such as inserting hyperlinks, headings, or a table of contents. In this manner, application of a rich visual effect does not limit the ability of a run of text to participate in the layout of a document or to have word processing or typographical functions applied thereto. According to other aspects, multiple rich visual effects can be simultaneously applied to a run of text in a similar manner.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a software architecture diagram showing aspects of a word processing application program provided herein in one embodiment that is capable of applying rich visual effects to arbitrary runs of text;

FIGS. 2A-2C are text diagrams showing several illustrative rich visual effects that may be applied to arbitrary runs of text in embodiments presented herein;

FIG. 3 is a text diagram showing a sample rich visual effect that has been applied to a run of text in a paragraph of a word processing document in one embodiment;

FIG. 4 is a text diagram showing aspects of one process provided herein for determining the dimensions of a run of text following the application of a rich visual effect in one embodiment presented herein;

FIGS. 5A-5B are flow diagrams showing one illustrative routine for applying rich visual effects to an arbitrary run of text according to one embodiment presented herein; and

FIG. 6 is a computer architecture diagram showing an illustrative computer hardware and software architecture for a computing system capable of implementing aspects of the embodiments presented herein.

### DETAILED DESCRIPTION

The following detailed description is directed to technologies for applying rich visual effects to arbitrary runs of text. Through the use of the technologies and concepts presented herein, an application program, like a word processing application program, can provide functionality for applying one or more rich visual effects to arbitrary runs of text while maintaining the ability of the run of text to participate in both layout and typographical functions.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for applying rich visual effects to arbitrary runs of text will be described.

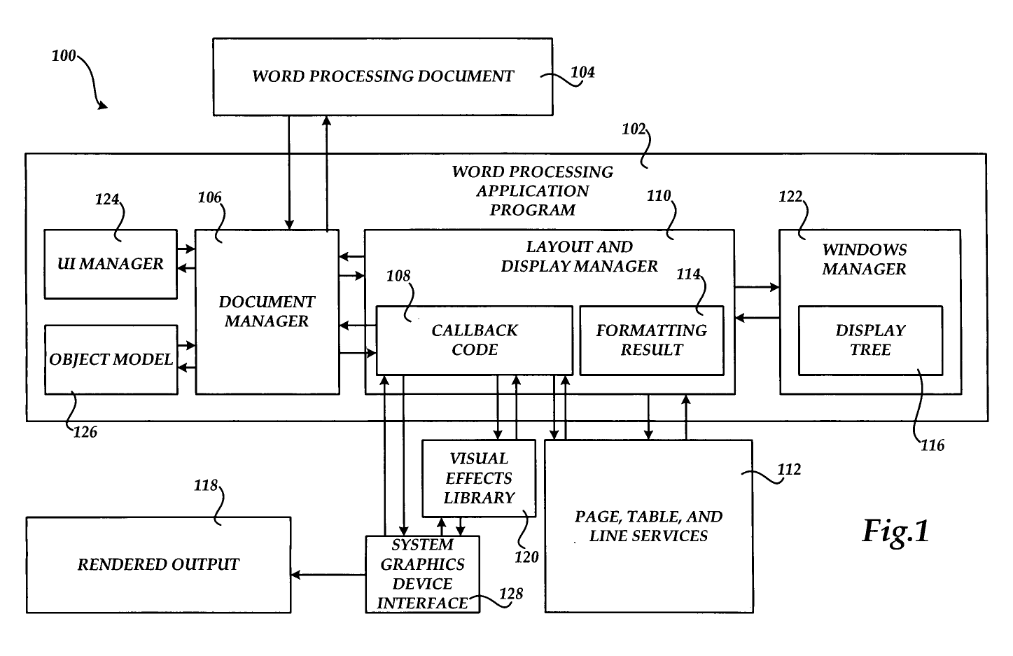

Turning now to FIG. 1, details will be provided regarding an illustrative operating environment and several software components provided by the embodiments presented herein. In particular, FIG. 1 shows aspects of a system 100 capable of applying rich visual effects to arbitrary runs of text. As used herein, the term “rich visual effect” refers to a visual effect that is not a property of a font. The term “run of text” refers to any amount of text. For instance, a run of text may include one or more characters, words, sentences, paragraphs, or combinations thereof.

According to embodiments, rich visual effects may include, but are not limited to fill, outline, shadow, glow, reflection, and bevel effects. A fill effect fills the text with a gradient, color, pattern, or a picture. An outline effect outlines the text with a line that has a gradient, color, weight, or a pattern. A shadow effect provides shading to one or more edges of the character to provide the illusion of a light source. A glow effect provides a soft border that extends outside all edges of the text. A reflection effect provides a mirror image of the text. A bevel effect applies a three-dimensional effect to the edges of the text. It should be appreciated that these rich visual effects are merely illustrative and that other rich visual effects may be applied in a similar manner. It should further be appreciated that visual modifications to a glyph that are specified as properties of a font are not within the definition of rich visual effects as specified herein. For instance, bold, italics, superscript, subscript, all caps, small caps, size, ligatures, alternate forms, and other properties of a font are not rich visual effects.

As shown in FIG. 1, the system 100 includes a word processing application program 102 that includes functionality for applying one or more rich visual effects to runs of text contained in a word processing document 104. In this regard, the word processing application program 102 provides a user interface for allowing a user to select an arbitrary run of text in the word processing document 104 and to request that a specified rich visual effect be applied to the selected run of text. Any suitable user interface (“UI”) and UI controls may be provided for allowing a user to select a run of text and for providing choices to the user regarding the available rich visual effects. The UI manager 124 provides and manages the UI elements described herein.

It should be appreciated that while the embodiments presented herein are described in the context of a word processing application program 102, the technologies and concepts presented herein may be utilized with virtually any type of program that provides functionality for creating and laying out text. For instance, the implementations presented herein may be utilized with page layout programs, desktop publishing programs, spreadsheet programs, presentation programs, text editors, World Wide Web (“Web”) page design programs, and other types of programs.

In order to lay out and render the word processing document 104, the word processing application program 102 operates in conjunction with a layout manager and display manager 110, a page, table, and page, table, and line services component 112, and a visual effects library 120. As will be discussed in greater detail below, the layout and display manager 110 provides document layout services to the word processing application program 102. In particular, the word processing application program 102 may communicate with the layout and display manager 110 to request the layout of portions of the word processing document 104. In order to facilitate communication with the page, table, and lines services 112, the word processing application program 104 may implement one or more callback routines, illustrated in FIG. 1 as callback code 108.

According to embodiments, the layout and display manager 110 provides facilities for laying out paragraphs of text. The paragraphs of text may include arbitrary runs of text that have rich visual effects applied thereto. The layout and display manager 110 provides these facilities in response to a request from the word processing application program 102 to layout a paragraph

The document manager 106 of the word processing application program 102 operates in conjunction with an object model 126, and may communicate with the layout and display manager 110 to request that a paragraph be laid out. The document manager 106 may also provide to the layout and display manager 110 the text and other content from the document 104 that should be laid into the paragraph. The document manager 106 may initially provide some of the content to the layout and display manager 110. The layout and display manager 110 may then request additional content from the callback code 108 as needed to lay out the text.

The document manager 106 may also indicate to the layout and display manager 110 the style of the text to be laid out. For instance, the document manager 106 may indicate the typestyle, size, and other information necessary to lay out the text to the layout and display manager 110. As will be described in greater detail below, the document manager 106 may also provide the dimensions of the text to which a rich visual effect is to be applied. The dimensions describe the dimensions of the text following the application of the rich visual effect to the text. In this manner, the layout and display manager 110 can consider the increased dimensions of the run of text as a result of the application of the rich visual effect during its layout-generating process.

During the process of laying out paragraphs of text, the layout and display manager 110 may utilize the services of a page, table, and line services component 27. The page, table, and line services component 112 is platform independent, and is operative to provide services with respect to pages, tables, and single lines of text. For instance, the page, table, and line services component 112 can produce sets of possible breaking points for a span of text. Potential breaking points include (for Western languages) space characters, hyphen characters, and grammatically correct breaking points within words. The breaking point information produced by the page, table, and line services component 112 may be utilized by a penalty function executing within the layout and display manager 110 to determine which breaking points and, consequently which paragraphs of text, are better than others. The page, table, and line services component 112 can also determine where between-character justification can be made for any language.

Once the layout and display manager 110 has laid out the text in the manner described herein, a formatting result 114 is passed back to the document manager 106. In response to receiving the formatting result 114, the document manager 106 is operative to update a display tree 116 maintained by the windows manager 122. Based on the changes to the display tree 116, the word processing application program 102 may update its rendered output 118 to display the formatting result to a user. The system graphics device interface (“GDI”) 128 may be utilized to draw the text. It should be appreciated that although the page, table, and line services component 112, the layout and display manager 110, and the visual effects library 120 have been illustrated as separate components, the functionality provided by these components may be provided by a common component or integrated into the word processing application program 102.

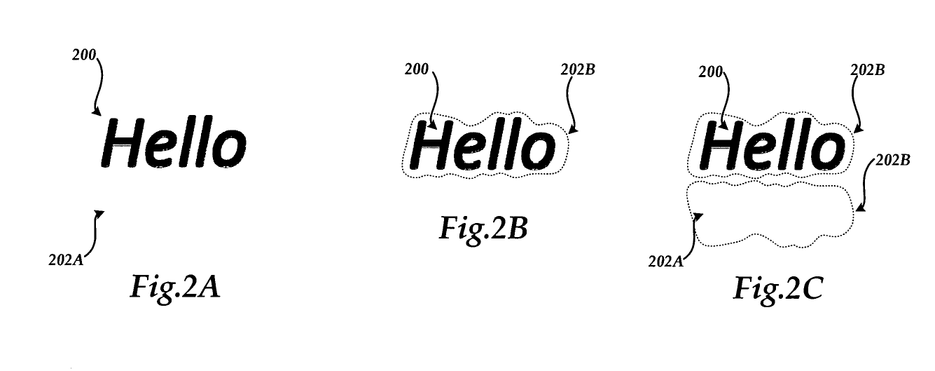

According to embodiments, the visual effects library 120 may be utilized to render runs of text that have rich visual effects applied thereto. For instance, according to embodiments, the visual effects library 120 is capable of rendering the fill, outline, shadow, glow, reflection, and bevel effects described above. Additional details regarding the operation of the word processing application program 102, the layout and display manager 110, the page, table, and line services component 112, and the visual effects library 120 for applying rich visual effects to arbitrary runs of text in a word processing document 104 are provided below with respect to FIGS. 2-6.

It should be appreciated that, according to embodiments, the word processing application program 102 performs a number of functions with respect to the contents of the word processing document 104. As will be described in greater detail below, these functions may be performed on text contained in the word processing document 104 that has had a rich visual effect applied thereto in the same manner as text contained in the word processing document 104 that has not had a rich visual effect applied thereto. In this manner, text that has had a rich visual effect applied thereto can be processed by layout, typographical, and word processing functions executed by the word processing application program 102 in the same manner as text that has not had a rich visual effect applied thereto. Layout functions refer to functions executed by the word processing application program 102 for laying out text on a page. Typographical functions refer to functions executed by the word processing application program 102 for modifying type glyphs and arranging type. Word processing functions include functions such as inserting hyperlinks, headings, or a table of contents.

Turning now to FIGS. 2A-2C, several text diagrams showing illustrative rich visual effects that may be applied to arbitrary runs of text in embodiments presented herein will be described. In particular, FIG. 2A shows a run of text 200 to which a rich visual effect 202A has been applied. In this example, the rich visual effect 202A is a reflection effect that provides a mirror image of the run of text 200. It should be appreciated that the application of the rich visual effect 202A increases the height of the run of text 200.

FIG. 2B shows the run of text 200 with a rich visual effect 202B applied thereto. In this example, the rich visual effect comprises a glow effect that provides a soft border that extends outside all edges of the run of text 200. Application of a glow effect as shown in FIG. 2B increases both the height and width of the run of text 200.

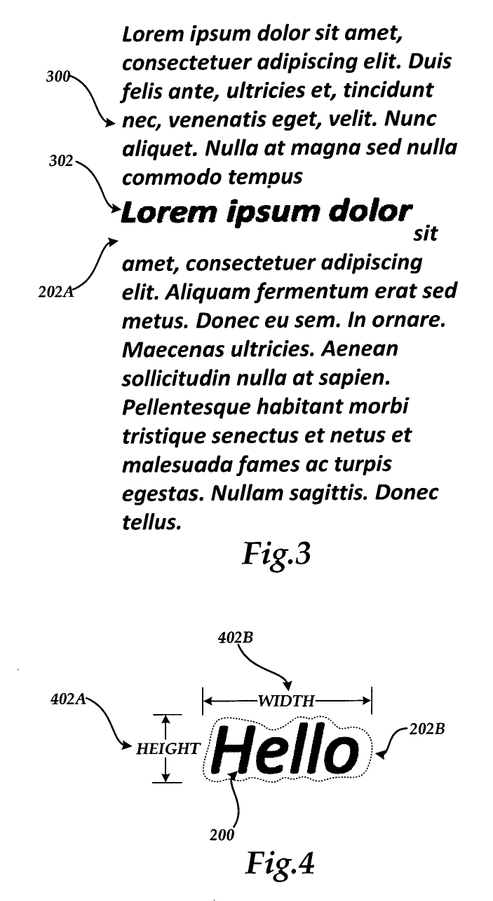

It should be appreciated that, according to embodiments, multiple rich visual effects may be simultaneously applied to the same run of text 200. For example, as shown in FIG. 2C, a rich visual effect 202A and a rich visual effect 202B may be applied to the same run of text 200. In this example, the rich visual effect 202A is a reflection effect and the rich visual effect 202B is a glow effect. Any number of rich visual effects may be simultaneously applied to the same run of text 200 in a similar manner. Additional details will be provided below with respect to FIGS. 3-6 regarding one process for applying the rich visual effects 202A-202B to the run of text 200.

Referring now to FIG. 3, a text diagram showing a sample rich visual effect that has been applied to a run of text in a paragraph of a word processing document 104 in one embodiment will be described. In particular, the text diagram shown in FIG. 3 illustrates one paragraph 300 of the word processing document 104. The paragraph 300 has been laid out and rendered by the word processing application program 102 operating in conjunction with the layout and display manager 110 and the page, table, and line services component 112 in the manner described above. The paragraph 300 includes a run of text 302 that has had a rich visual effect 202A applied thereto. In this example, the rich visual effect 202A comprises a reflection effect.

It should be appreciated that the run of text 302 having the rich visual effect 302 applied thereto shown in FIG. 3 has participated fully in the layout of the paragraph 300. That is, the run of text 302 has participated fully in the layout functions performed by the layout and display manager 110, the page, table, and line services component 112, and the document manager 106 to lay out the paragraph 300. From the perspective of the layout functions, the run of text 302 is no different than the remainder of the text in the paragraph 300 that has not had a rich visual effect applied thereto.

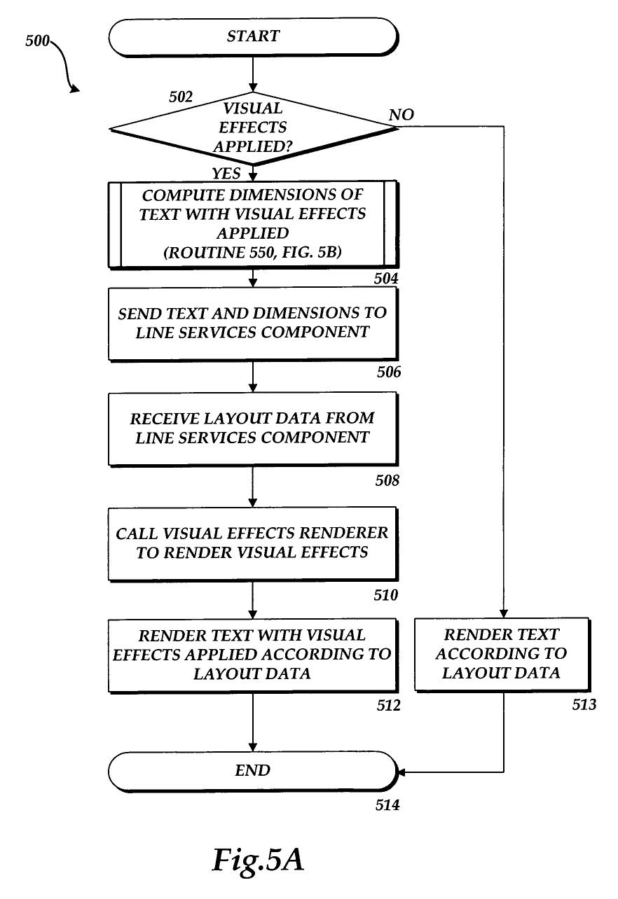

Turning now to FIG. 4, a text diagram showing aspects of one process provided herein for determining the dimensions of a run of text following the application of a rich visual effect will be described. As discussed briefly above, the document manager 106 provides the dimensions of a run of text to which a rich visual effect is to be applied to the layout and display manager 110. In particular, the document manager 106 provides the dimensions of the run of text following the application of the rich visual effect, or effects, to the layout manager.

In one embodiment, the dimensions of a run of text to which a rich visual effect is to be applied are determined without rendering the run of text with the rich visual effect applied thereto. For instance, in one implementation the dimensions are determined through the use of a parameter associated with the rich visual effect that indicates how the dimensions of the run of text will be modified following the application of the rich visual effect to the run of text. For instance, the parameter may indicate that application of a glow effect will cause the height and width of a run of text to increase by a specified percentage. The parameter may be specified in absolute or relative terms. If specified in relative terms, the parameter is relative to the font size of the run of text.

With regard to the example shown in FIG. 4, a rich visual effect 202B has been applied to the run of text 200. In this example, the rich visual effect 202B is a glow effect. The rich visual effect 202B causes both the height 402A and the width 402B of the run of text 200 to be increased. In this case, a parameter may be associated with the rich visual effect 202B that describes how the height 402A and the width 402B of the run of text 200 will be modified following the application of the rich visual effect 202B. For instance, the parameter may define in absolute terms (i.e. the number of pixels, points, or inches) the amount that the height 402A and 402B will increase as a result of the application of the rich visual effect 202B. Alternately, the parameter may define the change to the dimensions of the run of text 200 as a result of the application of the rich visual effect 202B thereto in relative terms (i.e. the height 402A will increase by ten percent and the width 402B will increase by five percent). It should be appreciated that the word processing application program may choose to use or to ignore any of the dimensions returned by the layout and display manager 110.

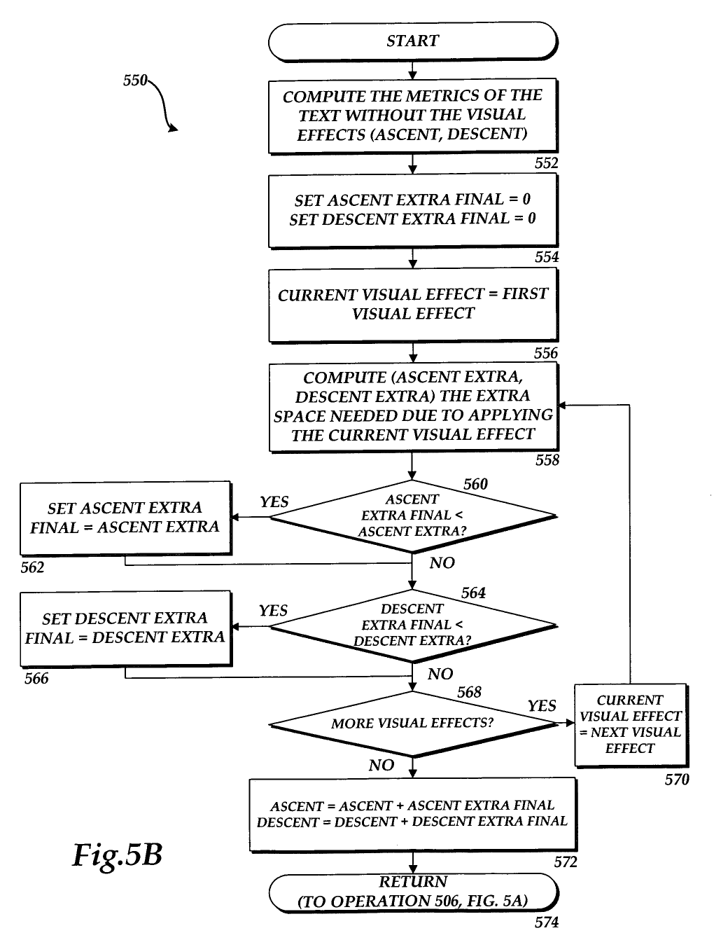

Referring now to FIGS. 5A-5B, additional details will be provided regarding the embodiments presented herein for applying rich visual effects to arbitrary runs of text. In particular, FIGS. 5A-5B are flow diagrams illustrating aspects of the operation of system 100 for applying rich visual effects to arbitrary runs of text. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 500 begins at operation 502, where a request is received to apply a rich visual effect to a run of text. For instance, as discussed above, the word processing application program 102 may provide a suitable user interface for allowing a user to select a run of text and to request that a rich visual effect be applied to the selected run of text. In response to receiving such a request, the routine 500 proceeds from operation 502 to operation 504. It should be appreciated that the process shown in FIG. 5 may be performed not only in response to a request to apply a rich visual effect to a run of text, but also in response to the modification of a run of text that previously had a rich visual effect applied thereto. If no visual effects have been applied to the run of text, the routine 500 proceeds from operation 513, where the run of text is rendered according to a layout generated without any rich visual effects applied thereto. From operation 513, the routine 500 proceeds to operation 514, where it ends.

At operation 504, the document manager 106 computes the dimensions of the run of text following the application of the rich visual effect thereto. As discussed above, a parameter associated with the rich visual effect that indicates how the dimensions of the run of text will be modified following the application of the rich visual effect to the run of text may be utilized to determine the dimensions. Where two or more rich visual effects are to be applied to all or a portion the run of text simultaneously with the first visual effect, the dimensions of the run of text following the application of all of the rich visual effects are determined. An illustrative process 550 is described below with reference to FIG. 5B for determining the dimensions of a run of text following the application of multiple visual effects thereto. Once the overall dimensions of the run of text with the rich visual effects applied thereto have been determined, the routine 500 continues from operation 504 to operation 506.

At operation 506, the document manager 106 transmits the run of text and the dimensions of the run of text following the application of the rich visual effect to the layout and display manager 110. In turn, this information may be transmitted to the page, table, and line services component 112 for determining a layout for the run of text. In response to receiving this information, the layout and display manager 110 and the page, table, and line services component 112 determine the layout for the run of text and return layout data to the document manager that indicates how the run of text should be laid out. As discussed above, this data may take the form of the formatting result 114 and is utilized to update the display tree 116. From operation 508, the routine 500 continues to operation 510.

At operation 510, the document manager 106 renders the display tree 116 to create the rendered output 118, which is displayed to a user. In this regard, the document manager 106 may utilize the services of the visual effects library 120 to render the rich visual effects. The routine 500 then continues to operation 512, where the run of text is rendered according to the generated layout with the rich visual effects applied thereto. From operation 512, the routine 500 continues to operation 514, where it ends.

Referring now to FIG. 5B, an illustrative routine 550 will be described that illustrates one process for determining the dimensions of a run of text following the application of multiple visual effects thereto. The routine 550 begins at operation 552, where the metrics of the run of text are computed without the visual effects applied thereto. The metrics are expressed using a variable (referred to as “ASCENT”) that defines the distance from the baseline of the text to the top of the line height of the text. The metrics are also expressed using a variable (referred to as “DESCENT”) that defines the distance from the baseline of the text to the bottom depth of the text. Once values for the ASCENT and DESCENT variables have been computed at operation 552, the routine 550 continues to operation 554.

At operation 554, variables are initialized to zero corresponding to the amount the ascent and descent of the run of text will be modified by the application of the rich visual effects. In particular, a variable referred to herein as ASCENT EXTRA FINAL corresponds to the amount the ascent of the run of text will be increased, and a variable referred to herein as DESCENT EXTRA FINAL corresponds to the amount the descent will increase as a result of the application of the rich visual effects. Both of these variables are initialized to zero at operation 554. From operation 554, the routine 550 continues to operation 556.

At operation 556, a variable corresponding to the current visual effect being considered is set equal to the first visual effect. The routine 550 then continues to operation 558, where the extra space needed due to applying the current visual effect is computed. The increase in the ascent is stored in a variable referred to as ASCENT EXTRA and the increase in the descent is stored in a variable referred to as DESCENT EXTRA. Once this operation has been performed, the routine 550 continues from operation 558 to operation 560.

At operation 560, a determination is made as to whether the value of the ASCENT EXTRA FINAL variable is less than the value of the ASCENT EXTRA variable. If not, the routine 550 continues from operation 560 to operation 564, described below. If so, the routine 550 proceeds from operation 560 to operation 562, where the ASCENT EXTRA FINAL variable is set equal to the value of the ASCENT EXTRA variable. The routine 550 then continues from operation 562 to operation 564.

At operation 564, a determination is made as to whether the value of the DESCENT EXTRA FINAL variable is less than the value of the DESCENT EXTRA variable. If not, the routine 550 continues from operation 564 to operation 568, described below. If so, the routine 550 proceeds from operation 564 to operation 566, where the DESCENT EXTRA FINAL variable is set equal to the value of the DESCENT EXTRA variable. The routine 550 then continues from operation 566 to operation 568.

At operation 568, a determination is made as to whether additional rich visual effects remain to be considered. If so, the routine 550 proceeds from operation 568 to operation 570, where the value of the variable utilized to refer to the current visual effect is set equal to the next rich visual effect to be considered. From operation 570, the routine 550 returns to operation 558 described above. If no additional visual effects remain to be considered, the routine 550 proceeds to operation 572, where the ascent for the current run of text is set equal to the ascent computed without application of the visual effects (ASCENT) plus the additional ascent generated as a result of the application of all of the rich visual effects (ASCENT EXTRA FINAL). The descent for the current run of text is set equal to the descent computed without application of the visual effects (DESCENT) plus the additional descent generated as a result of the application of all of the rich visual effects (DESCENT EXTRA FINAL). From operation 572, the routine 550 continues to operation 574. At operation 574, the routine 550 returns to operation 506, where the computed dimensions are sent to the page, table, and line services component 112 in the manner described above.

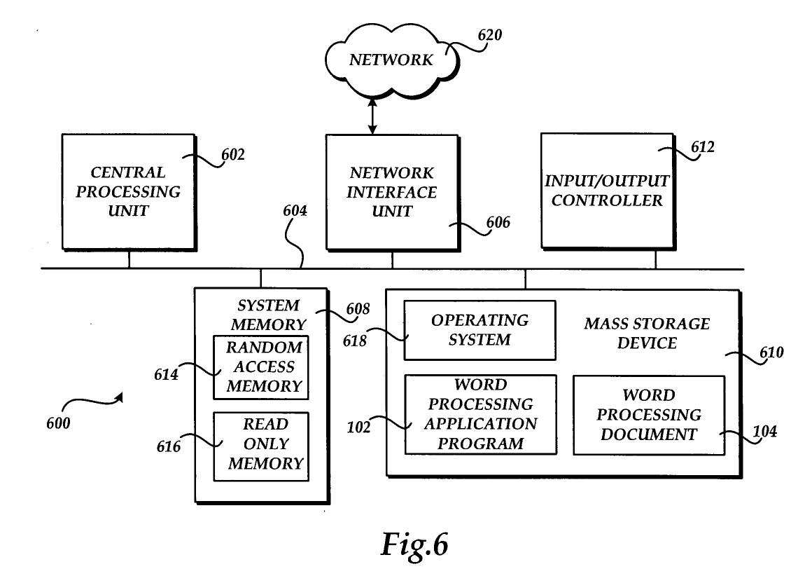

The FIG. 6 shows an illustrative computer architecture for a computer 600 capable of executing the software components described herein for applying rich visual effects to arbitrary runs of text in the manner presented above. The computer architecture shown in FIG. 6 illustrates a conventional desktop, laptop, or server computer and may be utilized to execute any aspects of the software components presented herein.

The computer architecture shown in FIG. 6 includes a central processing unit 602 (“CPU”), a system memory 608, including a random access memory 614 (“RAM”) and a read-only memory (“ROM”) 616, and a system bus 604 that couples the memory to the CPU 602. A basic input/output system containing the basic routines that help to transfer information between elements within the computer 600, such as during startup, is stored in the ROM 616. The computer 600 further includes a mass storage device 610 for storing an operating system 618, application programs, and other program modules, which are described in greater detail herein.

The mass storage device 610 is connected to the CPU 602 through a mass storage controller (not shown) connected to the bus 604. The mass storage device 610 and its associated computer-readable media provide non-volatile storage for the computer 600. Although the description of computer-readable media contained herein refers to a mass storage device, such as a hard disk or CD-ROM drive, it should be appreciated by those skilled in the art that computer-readable media can be any available computer storage media that can be accessed by the computer 600.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network such as the network 620. The computer 600 may connect to the network 620 through a network interface unit 606 connected to the bus 604. It should be appreciated that the network interface unit 606 may also be utilized to connect to other types of networks and remote computer systems. The computer 600 may also include an input/output controller 612 for receiving and processing input from a number of other devices, including a keyboard, mouse, or electronic stylus (not shown in FIG. 6). Similarly, an input/output controller may provide output to a display screen, a printer, or other type of output device (also not shown in FIG. 6).

As mentioned briefly above, a number of program modules and data files may be stored in the mass storage device 610 and RAM 614 of the computer 600, including an operating system 618 suitable for controlling the operation of a networked desktop, laptop, or server computer. The mass storage device 610 and RAM 614 may also store one or more program modules. In particular, the mass storage device 610 and the RAM 614 may store the word processing application program 102 and the word processing document 104, each of which was described in detail above with respect to FIGS. 1-5. It should be appreciate that although the word processing application 102 is illustrated and described herein as executing on a stand-alone computer 600, it should be appreciated that in other implementations the word processing application 102 is executed on a separate device and provided as a shared service. The mass storage device 610 and the RAM 614 may also store other types of program modules.

Based on the foregoing, it should be appreciated that technologies for applying rich visual effects to arbitrary runs of text are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for applying a rich visual effect to an arbitrary run of text, the method comprising:
receiving a request to apply a rich visual effect to a run of text; and
in response to the request, determining one or more dimensions of the run of text (200) following the application of the rich visual effect to the run of text,
determining a layout for the run of text utilizing the dimensions of the run of text following the application of the rich visual effect to the run of text, and
rendering the run of text with the rich visual effect applied thereto according to the layout.

2. The method of claim 1, further comprising providing one or more layout functions that can be utilized in conjunction with the run of text prior to the application of the rich visual effect, and wherein the one or more layout functions can be utilized in conjunction with the run of text following the application of the rich visual effect to the run of text.

3. The method of claim 1, further comprising providing one or more typographical functions that can be utilized in conjunction with the run of text prior to the application of the rich visual effect, and wherein the one or more typographical functions can be utilized in conjunction with the run of text following the application of the rich visual effect to the run of text.

4. The method of claim 1, further comprising one or more word processing functions that can be utilized in conjunction with the run of text prior to the application of the rich visual effect, and wherein the one or more word processing functions can be utilized in conjunction with the run of text following the application of the rich visual effect to the run of text.

5. The method of claim 1, wherein determining a layout for the run of text utilizing the dimensions of the run of text following the application of the rich visual effect to the run of text comprises:
providing the run of text and the dimensions of the run of text following the application of the rich visual effect to the run of text to a line services component;
receiving from the line services component layout data indicating how the run of text should be laid out; and
determining the layout for the run of text utilizing the layout data received from the line services component.

6. The method of claim 1, wherein a parameter is associated with the rich visual effect that indicates how the dimensions of the run of text will be modified following the application of the rich visual effect to the run of text, and wherein the parameter is utilized to determine the dimensions of the run of text following the application of the rich visual effect to the run of text.

7. The method of claim 1, further comprising:
receiving a request to apply a second rich visual effect to the run of text; and
in response to the request, determining dimensions of the run of text following the application of the rich visual effect and the second rich visual effect to the run of text,
determining a layout for the run of text utilizing the dimensions of the run of text following the application of the rich visual effect and the second rich visual effect to the run of text, and
rendering the run of text with the rich visual effect and the second rich visual effect applied thereto according to the layout.

8. A computer storage medium having computer executable instructions stored thereon which, when executed by a computer, cause the computer to:
determine one or more dimensions of a run of text following the application of a rich visual effect to the run of text;
determine a layout for the run of text based upon the determined dimensions; and to
utilize the layout to render the run of text with the rich visual effect applied thereto.

9. The computer storage medium of claim 8, having further computer executable instructions stored thereon which, when executed by the computer, cause the computer to determine the dimensions of the run of text based upon a parameter associated with the rich visual effect that indicates how one or more dimensions of the run of text will be modified following the application of the rich visual effect to the run of text.

10. The computer storage medium of claim 9, having further computer executable instructions stored thereon which, when executed by the computer, cause the computer to execute a line services component and to determine the layout for the run of text by:
providing the run of text and the dimensions of the run of text following the application of the rich visual effect to the run of text to the line services component;
receiving from the line services component layout data indicating how the run of text should be laid out; and
determining the layout for the run of text utilizing the layout data received from the line services component.

11. The computer storage medium of claim 8, having further computer executable instructions stored thereon which, when executed by the computer, cause the computer to:
receive a request to apply a second rich visual effect to the run of text; and
in response to the request, to determine one or more dimensions of the run of text following the application of the rich visual effect and the second rich visual effect to the run of text, to determine a layout for the run of text utilizing the dimensions of the run of text following the application of the rich visual effect and the second rich visual effect to the run of text, and to render the run of text with the rich visual effect and the second rich visual effect applied thereto according to the layout.

12. The computer storage medium of claim 8, having further computer executable instructions stored thereon which, when executed by the computer, cause the computer to provide one or more functions that can be utilized with the run of text prior to the application of the rich visual effect, and wherein the one or more functions can be utilized with the run of text following the application of the rich visual effect to the run of text.

13. The computer storage medium of claim 10, wherein the one or more functions comprise layout functions and typographical functions.

14. A system for applying a rich visual effect to an arbitrary run of text (200), the system comprising:
a line services component configured to receive the run of text and dimensions of the run of text and to determine a layout for the run of text based thereupon; and
a word processing application program configured to apply the rich visual effect to the run of text by determining the dimensions of the run of text following the application of the rich visual effect, providing the run of text and the dimensions of the run of text to the line services component, receiving from the line services component a layout for the run of text, and rendering the run of text with the rich visual effect applied thereto based upon the received layout.

15. The system of claim 14, wherein the word processing application program is further configured to provide one or more functions that can be utilized with the run of text prior to the application of the rich visual effect, and wherein the one or more functions can be utilized with the run of text following the application of the rich visual effect to the run of text.

16. The system of claim 15, wherein the one or more functions comprise layout functions.

17. The system of claim 16, wherein the one or more functions further comprise typographical functions.

18. The system of claim 17, wherein a parameter is associated with the rich visual effect that indicates how the dimensions of the run of text will be modified following the application of the rich visual effect to the run of text, and wherein the parameter is utilized by the word processing application program to determine the dimensions of the run of text following the application of the rich visual effect to the run of text.

19. The system of claim 18, wherein the word processing application program is further configured to receive a request to apply a second rich visual effect to the run of text and, in response to the request, to determine one or more dimensions of the run of text following the application of the rich visual effect and the second rich visual effect to the run of text, to utilize the line services component to obtain a layout for the run of text following the application of the rich visual effect and the second rich visual effect to the run of text, and to render the run of text with the rich visual effect and the second rich visual effect applied thereto according to the layout.

20. The system of claim 19, wherein the first visual effect and the second visual effect comprise one or more of a reflection effect, a glow effect, or a bevel effect.
